(19) United States
(12) Patent Application Publication
(10) Pub. No.: US 2025/0358576 A1
(43) Pub. Date: Nov. 20, 2025

(54) HEADBAND FOR A BONE ANCHORED HEARING SYSTEM

(71) Applicant: Oticon Medical A/S, Smarum (DK)

(72) Inventors: Martin KARLSSON, Askim (SE); Vikram SHETTY, Askim (SE); Olle LINDÉN, Höllviken (SE); Johan BIRGER, Höllviken (SE); Scott VANCE, Lewisburg, PA (US)

(21) Appl. No.: 19/206,097

(22) Filed: May 13, 2025

(30) Foreign Application Priority Data
May 17, 2024 (EP) 24176689.8

(51) Int. Cl. H04R 25/00

(52) U.S. Cl. CPC H04R 25/60

(57) ABSTRACT

Disclosed herein are embodiments of a headband configured for non-surgical retention of at least one abutment of a bone-anchored hearing system. The heading can include a support configured to retain the hearing system on a user's head, as well as at least one abutment configured to transmit vibrations generated by a vibration generating unit. The headband can include further attachment elements for retaining the headband onto the user.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of headbands for bone anchored hearing systems, and bone anchored hearing systems including headbands.

### BACKGROUND

For certain hearing-impaired users, a viable way to improve their hearing significantly may be a so-called bone anchored hearing system (BAHS) or bone anchored hearing aid where an implant is typically anchored to the user's mastoid bone. The implant will have direct contact to the mastoid bone and therefore will transmit the structure-borne sound generated by an associated vibration generator much better to the cochlea than a non-surgical solution (typically implemented as so-called neckbands, headbands, soft-bands, or sound connectors) where a layer of skin and underlying tissue has to transfer sound as mechanical vibrations to the user's mastoid bone. Hence, evaluating if good structure-borne sound transmission via the mastoid bone to the hearing apparatus is available and viable for a hearing-impaired user is key for the user to be able to decide if such a bone anchored hearing system (BAHS) is a way that they want to move forward with. Therefore, a non-surgical hearing system that is optimized for transferring sound through skin into the mastoid bone and further to the cochlear, as an evaluation device, will give a much better representation of what a user can expect form having an implant.

In any case, comfort is important for such evaluation devices as the user should be able to wear the evaluation devices the whole day for many days for then to be able to properly evaluate the potential benefit from a bone anchored hearing system (BAHS). Previously known solutions typically have comfort issues as they apply too much pressure to a small area of the user's head. On the other hand, solutions that easily dislocate from their correct position and solutions that cannot be individually fitted to the user's head lead to dissatisfying evaluation results.

Therefore, there is a need to provide a solution that addresses at least some of the above-mentioned problems. In particular, there is a need to provide a solution that allows for improving user comfort while enabling proper evaluation if a bone anchored hearing system (BAHS) is a viable approach to improve a user's hearing. There is a need for a discreet, non-surgical option to support bone anchored hearing systems (BAHS trials) for both adult and young patients who do not necessarily want to use soft bands.

Different head shapes and sizes pose an issue for sound transfer as it is important for the abutment-to-skin interface to have an even pressure distribution. Enough pressure must be applied by the neckband on the abutment while not causing discomfort for the user, as well as giving the users an option to adjust position to gain optimal sound transfer and comfort while wearing it for long durations at a time.

### SUMMARY

In an aspect of the present application, a headband is provided. The headband is configured for non-surgical retention of an abutment of a bone-anchored hearing system. The headband comprises a support configured to retain the hearing system on a user's head. The headband comprises at least one abutment configured to transmit vibrations generated by a vibration generating unit. The headband comprises an abutment holder associated with the support and configured to retain the at least one abutment. The support is configured to be placed on a user's head such that the at least one abutment contacts the user's head in an area surrounding one of the user's ears. The support comprises at least one telescoping feature configured to adjust a length of the support. The abutment holder is configured to retain the at least one abutment with a self-aligning two-axis swivel.

Advantageously, self-aligning two-axis swivel can provide for better fit of the headband onto a user's heard. For example, the disclosed headband can allow for improved comfort of a user and/or improved transmission of vibrations to the user. Further, the disclosed swivel can ease the abutment to align on the contours of the head as per the user's adjustment of the headband on the head. In contrast with a stiff abutment holder, this subtle adjustment of the swivel, provides a better/larger contact area with the mastoid bone. Further, in certain implementations, the headband is designed to be aligned at an angle on the user's head so that it just does not fall of the back of the head unlike a conventional headphone worn directly over the head.

In an aspect of the present application, a headband is provided. The headband is configured for non-surgical retention of an abutment of a bone-anchored hearing system. The headband hearing system includes a support configured to retain the hearing system on a user's head. The headband includes at least one abutment configured to transmit vibrations generated by a vibration generating unit. The headband includes an abutment holder associated with the support configured to retain the at least one abutment. The support is configured to be placed on a user's head such that at least one abutment contacts the users head in an area surrounding one of the user's ears. The at least one abutment is configured to receive an adhesive. The abutment holder is associated with the support via a self-aligning swivel component. The at least one abutment is configured to retain the abutment holder via a bayonet style coupling (e.g., engagement). The abutment holder can be associated with the support via a self-aligning swivel. The at least one mounting plate is configured to receive an adhesive.

Advantageously, self-aligning swivel can provide for better fit of the headband onto a user's heard. For example, the disclosed headband can allow for improved comfort of a user and/or improved transmission of vibrations to the user. Further, the bayonet style coupling can allow for ease of attachment (e.g., coupling and/or decoupling) of the abutment holder onto the support. This can allow the at least one abutment to be attached to the user, and the support attached to the at least one abutment afterwards. Further, the swivel-component is suspended in the center-axis where the force is transferred from the neckband, therefore preventing a bending torque that could force the patch off the skin.

In an aspect of the present application, a headband is provided. The headband is configured for non-surgical retention of an abutment of a bone-anchored hearing system. The headband includes a support configured to retain the hearing system on a user's head. The headband includes at least one abutment configured to transmit vibrations generated by a vibration generating unit. The headband includes an abutment holder associated with the support and configured to retain the at least one abutment. The support is configured to be placed on a user's head such that the at least one abutment contacts the users head in an area surrounding one of the user's ears. The support comprises at least one stopper configured to adjust a length of the support.

The disclosed headband advantageously allows for a very light weight, adjustable headband. The disclosed headband can rotate and revolve inside the abutment holder in two planes at the same time while preventing translation in any direction and adjust as per the contours of the head when the user adjusts the headband as per their comfort. The swivel movements allow the abutment to maximize contact area with the head and in turn provide a better sound transfer to the skull. The headband is retained in its position by ear hooks which are replaceable meaning they can be exchanged with custom hooks as per user's requirements.

In an aspect of the present application, a headband is provided. The headband is configured for non-surgical retention of an abutment of a bone-anchored hearing system. The headband includes a support configured to retain the hearing system on a user's head. The headband includes an abutment configured to transmit vibrations generated by a vibration generating unit. The headband includes an abutment holder associated with the support configured to retain the abutment. The support is configured to be placed on a user's head such that the abutment contacts the users head in an area surrounding one of the user's ears. The abutment holder comprises at least one partially loaded spring configured to provide an inward force on the user's head.

The disclosed headband advantageously is a length adjustable preformed headband which can provide the adjustability for different head sizes and the force on the abutment in contact with the head. The length adjustment of the band can be based on a spring click system. The abutment holder rotates on an axle and is pre-loaded with a torsion spring which provides extra force to firmly retain the abutment on the head while also self-aligning as per the skull contours of the user. The abutment itself is suspended in the clearance of the feedback decoupler. The extra force generated by the torsion spring ensures that the abutment advantageously provides a better sound transfer (e.g., vibration transfer) to the skull. Apart from generating extra force, the mechanism maximizes abutment contact with the skull in turn leading to a better sound transmission. The neckband can be retained in its position by ear hooks which are replaceable, meaning they can be exchanged with custom hooks as per user's requirements.

In an aspect of the present application, a headband is provided. The headband is configured for non-surgical retention of an abutment of a bone-anchored hearing system. The headband includes a support configured to retain the hearing system on a user's head. The headband includes at least one abutment configured to transmit vibrations generated by a vibration generating unit. The headband includes an abutment holder associated with the support and configured to retain the at least one abutment. The support is configured to be placed on a user's head such that the at least one abutment contacts the users head in an area surrounding one of the user's ears. The support comprises an aperture having a track, wherein the abutment holder is configured to translate along the track.

Advantageously, the disclosed headband is based on an over the head retention system. A length adjustable preformed headband can advantageously provide the adjustability for different head sizes, as well as the force on the abutment in contact with the head. The abutment holder consists of a 360-degree self-aligning swivel and a feedback decoupler. The abutment is then suspended in the clearance of the feedback decoupler. The swivel can rotate and revolve inside the abutment holder in two planes at the same time while preventing translation in any direction and adjust as per the contours of the head when the user adjusts the neckband as per their comfort. The abutment is suspended in the clearance of the feedback decoupler. The abutment holder can be snapped onto the tracks of the neckband frame and is retained in position by friction. The tracks provide a suitable placement of the abutment as per the user's comfort.

There can be advantages that apply for all of the above-described headbands. For example, each of the headbands is a discreet, length adjustable headband for different head sizes, comfortable, and user-friendly solution to be able to challenge the low BAHS penetration rate. A single point of attachment can advantageously be used at the abutment side to ensure an optimum sound transfer (e.g., more pressure, more sound). Further, the headbands are advantageous as they are design in such a way that the abutment is oriented on the mastoid bone which is the optimum location for the best sound transfer. Moreover, the disclosed headbands can be used for both unilateral and bilateral solutions.

Disclosed herein are a number of headbands (e.g., hearing systems). The headbands can be used with bone anchoring hearing systems (BAHS). In certain examples, the BAHS can include the headband. As used herein, a headband can also be understood as a neckband. In certain examples, a neckband can be considered a headband that extend along the back of a user's head.

Disclosed herein are embodiments of a headband. The headband can be sized and/or configured to fit fully around a user's head. The headband can be sized and/or configured to partially fit around a user's head. For example, the headband can be sized and/or configured to fit around the back of a user's head. For example, the headband can be sized and/or configured to fit around the top of a user's head.

In other words, the headband is configured for wearing on top of the user's head. For example, the headband and/or support can pass over the crown of the user's head. The support and/or the headband can extend from one side of the user's head to the other side of the user's head.

Embodiments of all of the disclosed headbands discussed herein can be configured for non-surgical retention of at least one abutment of a bone-anchored hearing system (BAHS). For example, the disclosed headbands can be used prior to implantation of one or more components of the BAHS. The disclosed headbands can be used prior to implantation of any components of the BAHS. In other words, embodiments of the disclosed headbands can be used as a precursor for the user to decide if they in future would like to opt for a BAHS surgical option. In certain situations, users can choose to keep the headband and not opt for surgical solution.

Moreover, while the design may be different as discussed in detail below, each of the disclosed headbands includes a support. The support is configured to retain the hearing system on a user's head. The support can be configured to retain the hearing system, for example, behind the user's head or on top of the user's head. In one or more example headbands, the support is configured for wearing on top of the user's head.

The support can be configured to retain the hearing system on the user's head so that vibrations can be transmitted from the hearing system to the user. For example, the support can be configured to provide an inward force on the user's head, thereby retaining the support and the hearing system, on the user's head. The support can be, for example, ring-shaped, C-shaped, halo-shaped, ¾ ring shaped, or U-shaped. For example, the support may fully or partially enclose (e.g., encircle) of head of the user. The support can have a first end and a second end (e.g., ends) in certain examples.

The support can include one or more features for retaining the support (e.g., the headband) to the user. For example, the support can include one or more earhooks which can be configured to interact with the user's ear(s) to retain the support on the user's head.

The headband (and/or the support) can be adjustable. The headband (and/or the support) can be adjustable in length in order to properly fit on a user's head.

The support can be, for example, metal or plastic. The support can be coated and/or covered, such as by a fabric material. The particular material is not limiting with respect to the support. The support can be preformed in order to apply an inward force.

In certain examples, the support can optionally include one or more earhooks. The earhooks may be permanently attached to the support. The earhooks may be removable. The earhooks may provide further stability for placing the headband on the user. The earhook(s) can be located generally at end(s) of the support.

The headband can include at least one abutment. The at least one abutment can be configured to transmit vibrations generated by a vibration generating unit (e.g., a vibration generating transducer). The at least one abutment can be generally flat a surface directed to the user. The at least one abutment can have a curved surface directed to the user. The at least one abutment can be sized and configured to conform with a mastoid bone (e.g., mastoid process, mastoid part, mastoid area) of the user. The at least one abutment can be located generally at the end(s) of the support. The at least one abutment can contact the user. In certain examples, the at least one abutment can include a foam on a side adjacent the user during wear. The foam can increase skin-contact surface of the at least one abutment.

In one or more example headbands, the at least one abutment comprises a single abutment. In one or more example headbands, the at least one abutment comprises two abutments. In one or more example headbands, the abutment holder comprises two abutment holders, wherein each of the two abutment holders is associated with one of the two abutments.

In certain examples, the at least one abutment comprises a plurality of abutments. In one or more example headbands, the headband may not include an abutment. The headband can be configured to receive and/or retain at least one abutment (for example, via the abutment support).

When two abutments are used, they can be located on opposite (or generally opposite) sides of the support and/or the headband. In this way, each of the abutments can be located on a respective mastoid bone (e.g., mastoid process, mastoid part, mastoid area) of the user. If two abutments are used, they can be located on generally opposite ends of the support. For example, a first abutment can be located on a first end of the support and a second abutment can be located on a second end of the support.

In one or more example headbands, the at least one abutment comprises a contact element. The contact element can be configured to transmit vibrations generated by the vibration generating unit towards a contact surface of the contact element.

With certain variants, the contact element may include a generally plate shaped contact section (e.g., connector surface) and a generally pin shaped connector section, wherein the contact section defines a plane of main extension, a radial direction and a circumferential direction, and the connector section defines a longitudinal axis. This provides a structure with a low volume and, hence, as such is of simple and light-weight design.

With certain variants, the support and the at least one abutment may be configured such that the at least one abutment, when contacting the user's head with the contact surface, for example, in an area of one of the user's mastoid bones, exerts a contact pressure on the user's head, the contact pressure resulting in an average contact pressure and a resultant contact force across the contact surface. At least some variants have a configuration where the contact pressure is kept close to but noticeably below (e.g., by at least 10%) the capillary closure pressure (typically about 0.37 N/cm2) of the contacted tissue, thereby ensuring proper perfusion of the contacted tissue and, hence, long term user comfort, while at the same time achieving proper vibration energy transmission.

With some variants, the resultant contact force may range from 1N to 4N, preferably 2N to 3.5N, more preferably 2.5N to 3N. As the shape of the head varies from person to person, the capillary closing pressure variates, it is therefore of beneficial if the contact pressure is adjustable. This may be provided by adjusting the length of the support or by bending the support. With some variants, the average contact pressure may range from 10N/cm2 to 60N/cm2, preferably 20N/cm2 to 50N/cm2, more preferably 35N/cm2 to 40N/cm2. These variants, alone or in combination, provide particularly favorable results as regards the balance between vibration energy transmission (i.e., hearing support) and user comfort. In particular, it has turned out that vibration energy transmission reaches a saturation level at these levels. Higher values for either the resultant contact force or the average contact pressure typically do not lead to noticeably increased vibration energy transmission while at the same time seriously affecting user comfort.

The connector section may protrude from the contact section in a direction facing away from the contact surface. The connector section, in the radial direction of the contact section, may be located substantially centrally at the contact section. Furthermore, the longitudinal axis of the connector section may be substantially perpendicular to the plane of main extension of the contact section.

With further variants, the contact section, in a perpendicular view onto the plane of main extension of the contact section, may have an outer contour selected from a group consisting of a section-wise curved contour, an elliptic contour, a circular contour, a section-wise polygonal contour. By this means an appropriately shaped contact surface yielding particularly good contact to the user's head in the region surrounding the user's ear (in particular, in the region of the user's respective mastoid bone) may be achieved.

With further variants, the contact section may have a thickness which tapers, in the radial direction, towards an outer contour of the contact section. These variants also yield a particularly simple and compact design which exhibits the advantages of low weight and high stiffness as described above.

The support is configured to be placed on a user's head such that the at least one abutment (e.g., the contact element) contacts the user's head in an area surrounding one of the user's ears. For example, the support is configured to be placed on a user's head such that the at least one abutment (e.g., the contact element) contacts the user's head in an area around the mastoid bone (e.g., mastoid process, mastoid part, mastoid area) of the user.

Any and/or all of the disclosed headbands can include the support and at least one abutment (e.g., including the contact element) as disclosed above. Further, the vibration generating unit can be connectable to any of the headbands disclosed herein.

Further, embodiments of each of the headbands disclosed herein can include an abutment holder (or at least one abutment holder). Each of the abutment holders can be associated with the support. For example, if two abutments are used, two abutment holders can be used (one abutment holder for each of the abutments). The abutment holder design can vary as discussed herein. In certain examples, the abutment holder (or plurality of abutment holders) can be located on end(s) of the support.

The abutment holder can be a part of the support. For example, the abutment holder can be integral with the support. The abutment holder can be separate from the support. The abutment holder can be connectable to the support.

In certain examples, a vibration generating unit can be removably attachable to the headband. In other examples, the vibration generating unit is a part of the headband. The vibration generating unit can be configured to transmit vibrations to the at least one abutment. The vibration generating unit can be attached and/or connected to the at least one abutment.

The vibration generating unit can include one or more microphones and a sound processing unit configured to process input sound signals captured by one or more microphones.

With certain variants, the vibration generating unit may be operatively coupled to the at least one abutment. With certain variants, the vibration generating unit may be operatively coupled to the abutment holder. The vibration generating unit may include a sound processing unit which is configured to process input sound signals captured (e.g., by one or more microphones) in order to generate appropriate vibration to be transmitted to the user's head in order to compensate for a hearing impairment of the user.

The vibration waves provided by a vibration generating unit travels through the support, the abutment holder, and/or the at least one abutment and onto the head of the user. If the travel distance of the vibration waves is as short as possible and as direct as possible, the efficiency of transferring the vibration waves onto the head of user is improved.

In one or more example headbands, the headband can be removably connectable to a plurality of vibration generating units. In certain examples, the number of vibration generating units is the same as the number of abutments.

With certain variants, the support and the at least one abutment may be configured such that the at least one abutment, when contacting the user's head with the contact surface in an area of one of the user's mastoid bones, exerts a resultant contact force across the contact surface in a resultant contact force direction. The at least one abutment be mounted to the support by a decoupling unit (e.g., feedback decoupler, decoupler). With some variants, the decoupling unit may decouple forces between the support and the at least one abutment in directions transverse, in particular, perpendicular, to the resultant contact force direction. With some variants, the decoupling unit may decouple moments between the support and the at least one abutment about an axis parallel to the direction of the resultant contact force direction. With some variants, the decoupling unit may be configured such that the at least one abutment is substantially freely rotatable with respect to the support unit about an axis parallel to the direction of the resultant contact force direction.

These variants, alone or in combination, enable largely decoupling the weight of the support unit from the at least one abutment. This has the beneficial effect that the contact conditions may be kept more uniform. Furthermore, user comfort may be enhanced. Moreover, the amount of sound or vibration energy passing to the support is reduced, which overall results in better vibration energy transfer, in particular, towards higher frequencies (in the human audible spectrum).

With certain variants, the decoupling unit may comprise a damping unit, thereby, in particular, reducing the leakage of vibration into the support. With some variants, the decoupling unit comprises a damping material selected from a damping material group consisting of flurosilicone, silicone, fluorocarbon, rubber, TPE and combinations thereof. These variants, alone or in combination, enable a reduction of the leakage of vibration into the support unit with the beneficial effects as outlined above. The hardness of a material may be determined by a shore value, and it has been found that for silicon a shore value between 10 and 40 and for flurosilicone a shore value between 20 and 40 is of benefit as the efficiency of the sound transmission is ideal within the ranges. Specially, a shore value about 25 of flurosilicone results in an even more improved efficiency.

In one or more example headbands, the support is C-shaped. For example, the support can be crescent shaped. In one or more example headbands, the support is oval and/or circular and/or ring shaped.

With certain variants, the support may be configured such that the at least one abutment, when contacting the user's head with the contact surface in an area of the user's mastoid bone on a first side of the user's head, exerts a resultant contact force across the contact surface in a resultant contact force direction by virtue of elastic deformation of the support unit, and the support unit may be configured such that the resultant contact force is substantially the only force exerted on the user's head on the first side of the user's head caused by the elastic deformation of the support. This configuration as well enables maintaining a largely stable and defined contact pressure at the contact surface of the at least one abutment.

In certain examples, the support can have a single strut. As used herein, strut can be, for example, a tube, a rod, a pole, etc. In certain examples, the support can have multiple struts. In certain examples, the support can have a single strut associated with the abutment holder and a double strut connecting the two single struts. The double struts can run generally parallel to one another. The double struts may allow for improved comfort of a user, as the double strut can be configured to rest on the user's head.

In one or more example headbands, the support includes at least one telescoping feature configured to adjust a length of the support. This feature can allow for adjustability for different shapes of user's heads. In other words, the support can be made from a number of different stuts that can be positioned inside of one another. That way, the different struts can slide into and out of one another, thereby adjusting the length of the support.

In certain examples, the single strut is a telescoping strut. In certain examples when there are two single struts, each of the single struts can be a telescoping strut. In certain examples when there are two single struts, only one of the two single struts is a telescoping strut. The telescoping strut can include one strut portion sliding into and/or out of another strut portion.

In certain embodiments, the abutment holder is configured to retain the at least one abutment with a self-aligning two-axis swivel. The swivel is considered “self-aligning” as it does not require user intervention (e.g., manual user adjustment) to adjust the correct placement of the swivel on the head. For example, the swivel, which is free to rotate around the axes, will do so automatically as per the contours of the head. In other words, the abutment holder allows the at least one abutment to rotate about two axes. In certain examples, the support can include a pair of abutment holders, each of the pair of abutment holders retaining one of the at least one abutment.

In one or more example headbands, the abutment holder comprises a body. In one or more example headbands, a first inner ring configured to be retained within the body. In one or more example headbands, a second inner ring configured to be retained within the first inner ring. In one or more example headbands, the first inner ring is configured to rotate with respect to the body about a first axis. In one or more example headbands, the second inner ring is configured to rotate with respect to the first inner ring about a second axis. In one or more example headbands, the first axis and the second axis are different.

In certain examples, the body can be considered a ring. In other words, the body can have a lumen (e.g., through hole, hole, gap) in it. For example, the lumen can be generally at the center of the body. The body can be associated with the support on an outer surface of the body (e.g., an outer surface of the abutment holder). The body (and therefore the abutment holder) can be connected to the support. For example, the body (and therefore the abutment holder) can be connected to an end of the support.

On a radially inner surface of the body (e.g., within the lumen), the body can include a pair of body slots. The pair of body slots can be located on generally opposite sides of the lumen. In certain examples, the each of the pair of body slots can contain a respective body divot.

The abutment holder can further include the first ring. The first ring can include a first ring lumen. The first ring can be generally circular in shape. The first ring can be configured to fit within the lumen of the body.

The first ring can include a pair of first ring protrusions. The pair of first ring protrusions can extend from a radially outer surface of the first ring. The pair of first ring protrusions can be generally opposite one another. The pair of first ring protrusions can be configured to be retained (e.g., held) within the pair of body slots. For example, the pair of first ring protrusions can be held within the respective body divots of the pair of body slots. The body may have some flexibility in order to receive and retain the first ring. Once the first ring is within the body, it can rotate about the first ring protrusions (e.g., about a first axis).

In certain examples, the first ring can have a lumen (e.g., through hole, hole, gap) in it. For example, the lumen can be generally at the center of the first ring.

On a radially inner surface of the first ring (e.g., within the lumen), the first ring can include a pair of first ring slots. The pair of first ring slots can be located on generally opposite sides of the lumen of the first ring. In certain examples, the each of the pair of first ring slots can contain a respective first ring divot.

The abutment holder can further include the second ring. The second ring can include a second ring lumen. The second ring can be generally circular in shape. The second ring can be configured to fit within the lumen of the first ring.

The second ring can include a pair of second ring protrusions. The pair of second ring protrusions can extend from a radially outer surface of the second ring. The pair of second ring protrusions can be generally opposite one another. The pair of second ring protrusions can be configured to be retained (e.g., held) within the pair of first ring slots. For example, the pair of second ring protrusions can be held within the respective first ring divots of the pair of first ring slots. The first ring may have some flexibility in order to receive and retain the second ring. Once the second ring is within the body, it can rotate about the sing ring protrusions (e.g., about a second axis).

The first axis and the second axis can be different. In this way, both the first ring and the second ring can rotate about different axes, allowing for variations in movement to allow a better fit of the abutment onto a user.

In one or more example headbands, the first axis and the second axis are orthogonal. In one or more example headbands, the first axis and the second axis are not orthogonal.

The first ring and the second ring are freely rotatable on the respective slots and divots, and therefore can self-align to a surface that is not parallel with the abutment holder and/or support.

The second ring can be configured to retainable receive the abutment. For example, the second ring can retain the abutment via a decoupling component, such as a silicone decoupling component. The second ring can include a lumen which is configured to removably receive a protrusion of the abutment.

In certain examples, the first ring and the second ring are configured to be snapped together. Other components can be used as well, such as a pin and circlip, screws, etc. to connect the first ring and the second ring.

Once the abutment is coupled to the second ring, the abutment can freely rotate on the first axis and/or the second axis, and therefore can self-align to a surface that is not parallel with the abutment holder (e.g., a user's head).

In certain example headbands, a different style of abutment holder can be used. The support and the at least one abutment can be the same as disclosed above. However, variations of the support can be used as well.

In one or more example headbands, the support can be C-shaped. In certain examples, the support, and thus the headband, can be sized and/or configured to follow along the back of a user's head. This can be done to avoid the support sitting on the top of a user's head. The support can include some flexibility so that it holds the at least one abutment onto the user's head, such as via one or more of pressure, friction, inward force.

The support can be adjustable for adjusting a length of the support. A telescoping feature can be used, similar to what was discussed above. Alternatively, or in conjunction, the ends of the support can slide along a band connecting the two ends. In this way, the length of the support can be adjusted. This can be construed as a slide-adjustable headband. The support can include a preformed metal strip. The preformed metal strip can apply any necessary force between the at least one abutment and the user.

The at least one abutment can be configured to receive an adhesive. The at least one abutment can be understood as an adhesive mounting plate. The adhesive can allow for the at least one abutment to more easily remain attached to the user's head. Further, the at least one abutment can be attached to a user prior to attachment of the remainder of the headband (e.g., the support, abutment holder, etc.) to the at least one abutment.

In other words, the user can connect the abutment holder to the at least one abutment (such as via the bayonet style coupling) after the at least one abutment is already located on the user. The abutment holder can include a quick release mechanism, which can be turned by the user to release the abutment holder from the at least one abutment.

The support can include a self-aligning swivel component. The abutment holder can be associated with the support via a self-aligning swivel component. For example, the abutment holder can be configured to rotate about an axis with respect to the support. The abutment holder can be connected to the support at two points to allow rotation.

The at least one abutment is configured to retain the abutment holder via a bayonet style coupling (e.g., bayonet mount). The bayonet style coupling may be understood as a bayonet style engagement. The at least one abutment is configured to retain the abutment holder via a bayonet style coupling to retain the abutment holder on. For example, the at least one abutment may have a first surface and a second surface opposite the first surface. The first surface can be relatively flat for an adhesive to be applied. The second surface can include a plurality of slots. The slots can be generally parallel to the first surface and/or the second surface.

The abutment holder can include a plurality of protrusions. The protrusions can be sized and configured to fit within the plurality of slots. The abutment holder can be put into contact with the second side of the at least one abutment and rotated so that the protrusions are retained within the plurality of slots. To remove the abutment holder, the abutment holder can be rotated in an opposite direction in order to remove the protrusions from the slots.

In certain examples, the number of protrusions in the plurality of protrusions can be the same as the number of slots in the plurality of slots. For example, the abutment holder may include four protrusions and the at least one abutment can include four slots.

The at least one abutment can include a pair of cutouts extending from the first surface to the second surface. For example, when the abutment holder is connected to the at least one abutment, they can sandwich (e.g., be on opposite sides of) the self-aligning swivel component. The pair of cutouts can be aligned with the axis of the self-aligning swivel component, allowing both the at least one abutment and the abutment holder to rotate with respect to the same axis as the self-aligning swivel component.

In one or more example headbands, the at least one abutment is on an opposite side of the support and the self-aligning swivel component from the abutment holder. This allows the self-aligning swivel component to be sandwiched between the at least one abutment and the abutment holder.

In one or more example headbands, the at least one abutment is configured to retain the self-aligning swivel component. For example, the self-aligning swivel component can fit on the second surface of the at least one abutment between the plurality of slots. Therefore, the self-aligning swivel component does not interfere with the attachment of the abutment holder to the at least one abutment.

In one or more example headbands, the support can include at least one stopper configured to adjust a length of the support. The at least one stopper can be located generally on the middle of the support. The support can be formed form a first support and a second support. The first support and the second support can be connected at the at least one stopper. The at least one stopper can be configured to hold an end of the first support or the second support. The other of the first support and the second support can translate through the at least one stopper. This can allow for adjustment of the length of the support.

In one or more examples, the support comprises a wire support. In one or more example headbands, the wire support is configured to retain the headband on a user's head via at least one configurable wire earhook.

In one or more examples, the wire support can include two preformed metallic wires held together by the at least one wire stopper. In one or more example headbands, the wire support comprises a first wire support and a second wire support.

In one or more example headbands, the headband (e.g., the support and/or the wire support) can includes two configurable wire earhooks.

In one or more example headbands, the at least one stopper comprises at least one wire stopper configured to adjust the length of the wire support.

The at least one wire stopper can be located generally on the middle of the wire support. The wire support can be formed form a first wire support and a second wire support (e.g., two preformed metallic wires). The first wire support and the second wire support can be connected at the at least one wire stopper. The at least one wire stopper can be configured to hold an end of the first wire support or the second wire support. The other of the first wire support and the second wire support can translate through the at least one wire stopper. This can allow for adjustment of the length of the wire support.

In other words, the at least one wire stopper can receive and retain an end of the first wire support. For example, the end of the first wire can be retained in a first aperture of the at least one wire stopper. The second wire support can extend through the at least one wire stopper via a second aperture of the at least one wire stopper. The first wire support can remain in fixed relationship with the at least one wire stopper. The second wire support can be configured to translate with respect to the at least one wire stopper (e.g., through the second lumen).

In one or more example headbands, the at least one wire stopper comprises a pair of wire stoppers. In one or more example headbands, the wire support comprises a wire holder located between the pair of wire stoppers. For example the at least one wire stopper can be a first wire stopper and a second wire stopper.

In other words, the first wire stopper can receive and retain an end of the first wire support. For example, the end of the first wire can be retained in a first aperture of the first wire stopper. The second wire support can extend through first wire stopper via a second aperture of the first wire stopper. The first wire support can remain in fixed relationship with first wire stopper. The second wire support can be configured to translate with respect to the first wire stopper (e.g., through the second lumen).

In other words, the second wire stopper can receive and retain an end of the second wire support. For example, the end of the second wire can be retained in a first aperture of the second wire stopper. The first wire support can extend through second wire stopper via a second aperture of the second wire stopper. The second wire support can remain in fixed relationship with second wire stopper. The first wire support can be configured to translate with respect to the second wire stopper (e.g., through the second lumen).

For example, each of the wire supports (e.g., the first wire support and the second wire support) can include a respective wire stopper (e.g., the first wire stopper and the second wire stopper) on the end of the respective wire support. The other of the wire supports is configured to translate with relation to the other of the wire stoppers, which allows for adjusting of the length of the wire support.

The wire support can also include a wire holder located between the pair of wire stoppers. The wire holder can be configured to retain both the first wire support and the second wire support. Both the first wire support and the second wire support can translate through the wire holder. The wire holder can be configured to prevent the wires of the wire support from twisting. The wire holder can be configured to stabilize the wires of the wire support during deployment.

In one or more example headbands, the wire holder comprises a first aperture and a second aperture. A first wire support of the wire support can extend through the first aperture. A second wire support of the wire support can extend through the second aperture.

In one or more example headbands, the abutment holder can include at least one partially loaded spring. The at least one partially loaded spring can be configured to provide an inward force on the user's head.

In certain examples, the support is preformed. The support can be configured to apply an inward force on the user's head. In certain examples, two different inward forces can be applied to the user's head. The first is from the preformed support. The second is from the at least one partially loaded spring.

For example, the support can have a C-shaped configuration. The support can have two ends (e.g., a first end and a second end). An abutment holder can be located at the first end and/or the second end. The at least one partially loaded spring can provide a force to at least partially rotate the abutment holder. This can maximize contact between the abutment with the user.

The at least one partially loaded spring can be configured to rotate the abutment holder about a rotation axis with respect to the support. In one or more examples, the rotation axis is orthogonal to the support.

In certain examples, the headband can include a plurality of partially loaded springs. Each of the plurality of partially loaded springs can be associated with one abutment holder. In other words, the term partially loaded can be understood to mean that the spring is not fully engaged. The spring would be fully engaged/loaded when the user places the headband on the head and as per the contours and shape of the user's head the spring will be loaded. In certain examples, the support can include the at least one partially loaded spring.

In one or more example headbands, the headband comprises a pair of partially loaded springs. For example, each of the pair of partially loaded springs can be located on opposite sides of a user's head when worn.

In one or more example headbands, the at least one partially loaded spring comprises a torsion spring. However, other types of springs can be used as well for the at least one partially loaded spring.

In certain examples, the support comprises an earhook. The earhook can be connected to the abutment holder. In certain examples, the at least one partially loaded spring can apply an inward force to the earhook. In one or more example headbands, the support comprises a pair of earhooks. Each of the pair of earhooks can be located on a different abutment holder. Each of the pair of earhooks can be located generally at the first end and second end of the support.

In one or more example headbands, the support is associated with the abutment holder via a self-aligning ball joint.

In one or more example headbands, the support includes an aperture. The aperture can include a track. The abutment holder can be configured to translate along the track. The aperture can be circular. The aperture can be ovaloid. The aperture can be curved. The aperture can follow along a surface of the support.

The abutment holder can include an outer surface configured to mate with the track. For example, the aperture holder can include one or more radially outwardly extending protrusions which are configured to interface with the track.

In certain examples, friction can be used between the abutment holder and the track to keep it from moving. The user will have to intervene to the abutment holder along the track.

In certain examples, the track may include bumps extending inward. The bumps can be used to retain the abutment holder's position on the track.

In certain examples, the headband can include a tightening mechanism (such as a nut) to tighten when the user finds the most suitable position for the abutment holder on the track. The tightening mechanism would then retain the abutment holder on the track.

In general, a hearing system (e.g., bone-anchored hearing system) can include i) an input unit such as a microphone for receiving an acoustic signal from a user's surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such directional microphone system is adapted to (relatively) enhance a target acoustic source among a multitude of acoustic sources in the user's environment and/or to attenuate other sources (e.g. noise). In one aspect, the directional system is adapted to detect (such as adaptively detect) from which direction a particular part of the microphone signal originates. This may be achieved by using conventionally known methods. The signal processing unit may include an amplifier that is adapted to apply a frequency dependent gain to the input audio signal. The signal processing unit may further be adapted to provide other relevant functionality such as compression, noise reduction, etc.

The output unit may generally include an output transducer such as a loudspeaker/receiver for providing an air-borne acoustic signal to the ear of the user, a mechanical stimulation applied transcutaneously or percutaneously to the skull bone. In some hearing devices, the output unit may include one or more vibrators for providing the mechanical stimulation to the skull bone.

### Definitions

In the present context, a hearing aid, e.g. a hearing instrument, refers to a device, which is adapted to improve, augment and/or protect the hearing capability of a user by receiving acoustic signals from the user's surroundings, generating corresponding vibration signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIGS. 1A-1D show a schematic of an example embodiment of a headband disclosed herein,

FIGS. 2A-2D show a schematic of an example embodiment of a headband disclosed herein,

FIGS. 3A-3B show a schematic of an example embodiment of a headband disclosed herein,

FIGS. 4A-4C show a schematic of an example embodiment of a headband disclosed herein, and

FIGS. 5A-5D show a schematic of an example embodiment of a headband disclosed herein.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of headbands, in particular those supporting a bone anchored hearing systems (BAHS).

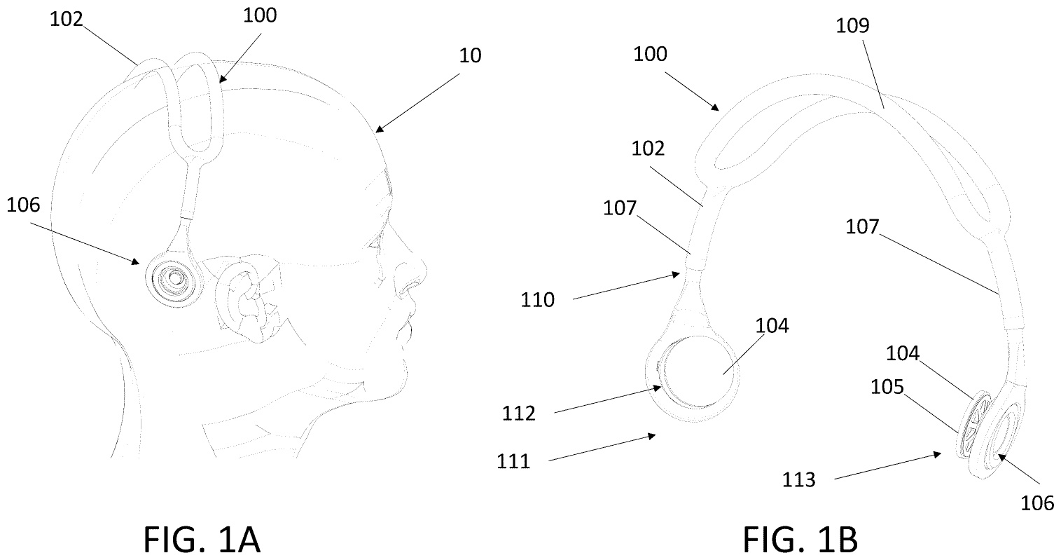

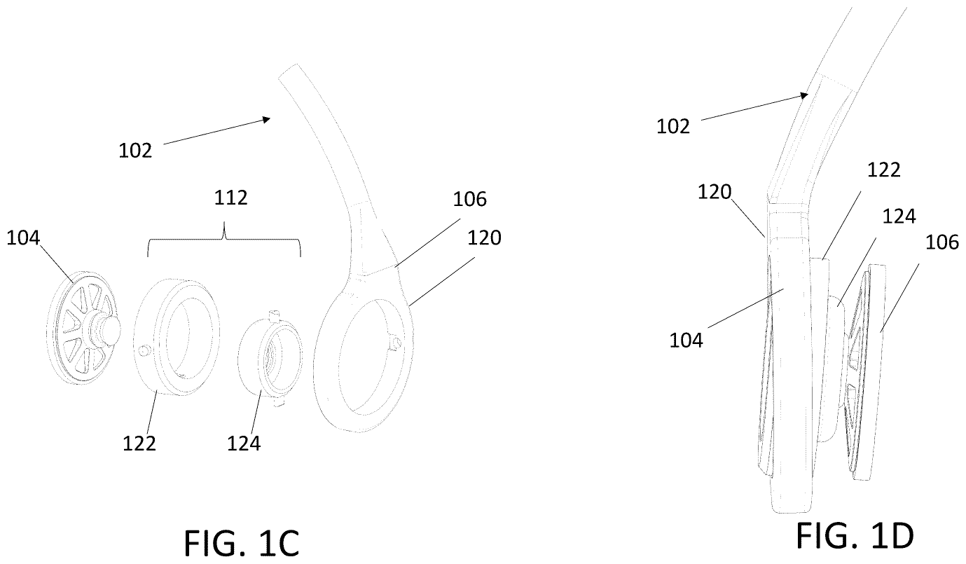

FIGS. 1A-1D show a schematic of an example embodiment of a headband disclosed herein, which is configured for non-surgical retention of at least one abutment of a bone-anchored hearing system.

As shown, the headband 100 can be worn by a user 10. In particular, the style of headband 100 shown in FIGS. 1A-1D can be configured for wearing on top of the user's head. The headband can include a support 102 configured to retain the hearing system (e.g., and the headband 100) on the user's head. As shown, the support 102 can partially wrap around the user's head. The support 102 can be C-shaped and thus have a first end 111 and a second end 113. A preformed shape of the support 102 and the telescopic connection 110 can provide adjustability for different head sizes of a user 10, as well as the force on the at least one abutment 104. The support 102 can extend and retract via the telescopic connection 110.

As shown in FIG. 1B, the support 102 can have a single strut 107 associated with the abutment holder and a double strut 109 connecting the two single struts 107.

The headband 100 can further include at least one abutment 104 which is configured to transmit from vibrations generated by a vibration generating unit. While the vibration generating unit is not show, it would be attachable at location 106. The vibration generating unit can attached the at least one abutment 104 and/or the support 102. The at least one abutment 104 can include a contact element 105. The contact element can be configured to transmit vibrations generated by the vibration generating unit towards a contact surface of the contact element 105. The contact element 105 can include a pad or foam in certain implementations.

The headband further includes an abutment holder 106 associated with the support 102 and configured to retain the at least one abutment 104. If more than one abutment 104 is used, the same number of abutment holders 106 can be used as well. In the embodiment shown in FIGS. 1A-1D, two abutments 104 and two abutment holders 106 are used.

In certain examples, the headband 100 can be unilateral, wherein it has a single abutment 104. In certain examples, the headband 100 can be bilateral, where it has two abutments 104.

As shown, the support 102 is configured to be placed on the user's head such that the at least one abutment 104 contacts the user's head in an ear surrounding one of the user's ears. For example, the at least one abutment can be in contact with the mastoid area of the user 10.

The support 102 can include at least one telescoping feature 110 configured to adjust a length of the support 102. As shown in FIG. 1B, the support 102 includes two telescoping features 110, one on each side of the support.

Further, the abutment holder 106 is configured to retain the at least one abutment 104 with a self-aligning two-axis swivel 112, shown more clearly in FIGS. 1C-1D.

As shown in the exploded schematic of FIG. 1C, the abutment holder 106 includes a body 120, a first inner ring 122, and a second inner ring 124. The first inner ring 122 is configured to be retained within the body 120 and the second inner ring 124 is configured to be retained within the first inner ring 122. The first inner ring can rotate with respect to the body 120 around a first axis and the second inner ring 124 can rotate with respect to the first inner ring 122 about a second axis. The first axis and the second axis are different, which allows for self-alignment and multi-axis swivelling. In certain implementation, the first axis and the second axis are orthogonal.

In other words, the abutment holder 106 can include two rings that are suspended in the support 102, freely swiveling on the axes to self-align to the user skull contours. Therefore, maximizing the contact surface between the at least one abutment 104 and skull for optimal sound transfer. The at least one abutment 104 itself can be suspended in the swivel by a feedback decoupler.

The two rings (first inner ring 122 and second inner ring 124) along with the body 120 can have 90 degrees spaced rotation axis. In this embodiment they are snapped together, but could as well be held in place e.g., with a pin and circlip, screws etc. In the center of the second inner ring 124 the at least one abutment is mounted in a silicone decoupling component. The inner rings 122, 124 are freely rotate on the axis/tabs and in the body 120, and therefore can self-align to a surface that is not parallel with the body 120.

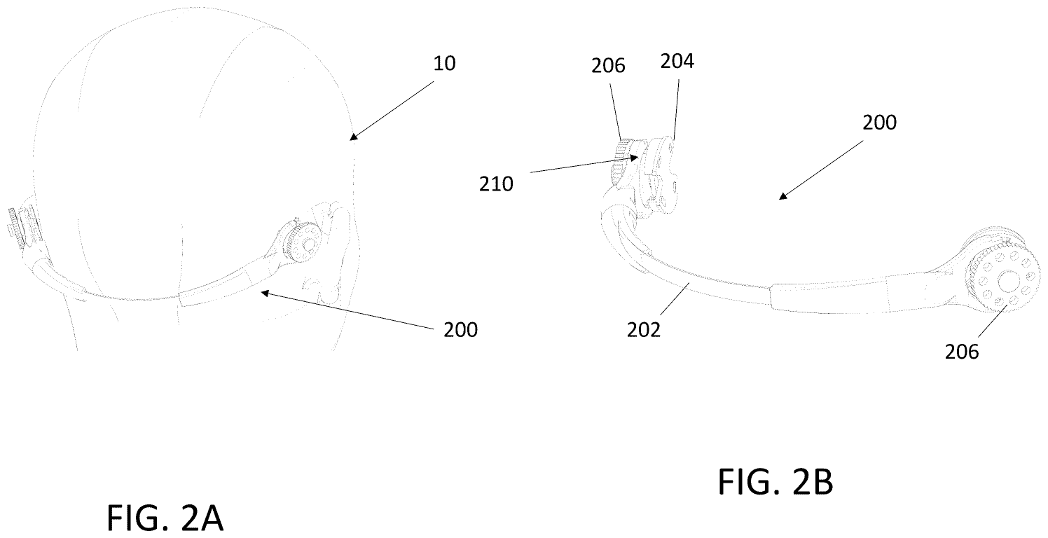

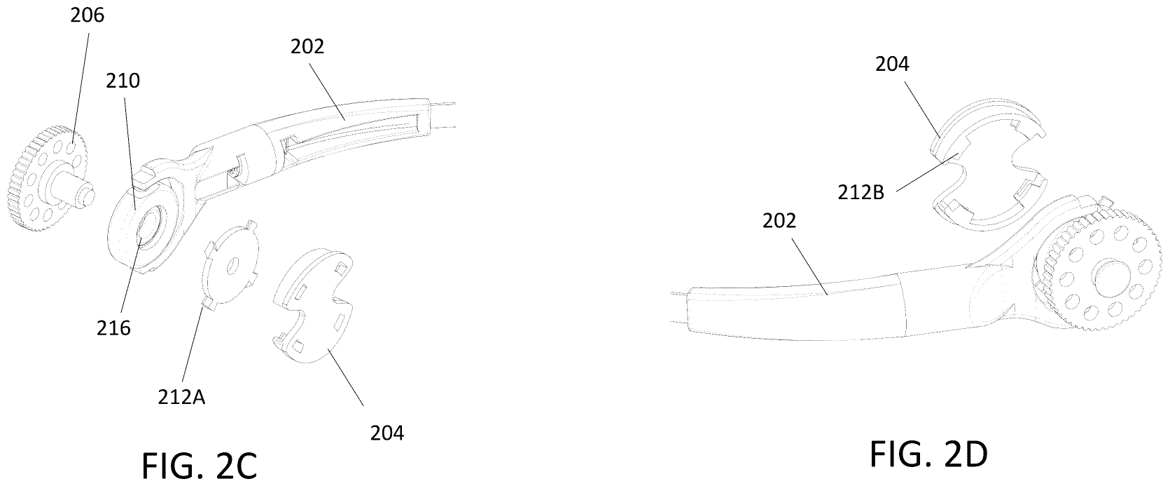

FIGS. 2A-2D show a schematic of an example embodiment of a headband disclosed herein, which is configured for non-surgical retention of at least one abutment of a bone-anchored hearing system.

As shown, the headband 200 includes a support 202 configured to retain the hearing system on the head of the user 10. Unlike the headband 100 (and support 102), the support 202 is configured to extend around the back of a user's head, rather than on top. The support 202 is C-shaped, which can allow it to fit around the back of the user's head.

The headband 200 includes at least one abutment 204 configured to transmit vibrations generated by a vibration generated unit. Further, the headband 200 includes an abutment holder 206 associated with the support 202 and configured to retain the at least one abutment 204. The support 202 is configured to be placed on a user's head such that at least one abutment 204 contacts the users head in an area surrounding one of the user's ears.

The at least one abutment 204 has been modified with respect to the one shown in FIGS. 1A-1D. In particular, the at least one abutment 204 is configured to receive an adhesive (and could be understood as an adhesive mounting plate). The adhesive can be applied on a surface of the at least one abutment 204 that interacts with the user when worn, thereby increasing the attachment of the headband 200 to the user 10. The headband 200 can include an adhesive in certain iterations.

The abutment holder 206 is associated with the support 202 via a self-aligning swivel component 210. Further, the at least one abutment 202 is configured to retain the abutment holder 206 via a bayonet style coupling 212A, 212B (shown in FIGS. 2C-2D).

As shown, the at least one abutment 204 is on an opposite side of the support 202 and the self-aligning swivel component 210 from the abutment holder 206. Therefore, the at least one abutment 204 and the abutment holder 206 sandwiches the self-aligning swivel component 210 between. In particular, the at least one abutment 204 is configured to retain the self-aligning swivel component 210.

As mentioned, the at least one abutment 204 with bayonet), is style coupling 212A, 212B (e.g., locking features placed on either side of the skull of the user 10. The support 202 is then attached to the at least one abutment via the bayonet quick engagement. The abutment acts as both the mounting and the quick engagement to reduce interfaces where losses can arise. The at least one abutment 204 can be mounted on a feedback decoupler 214 which in turn is mounted inside a self-aligning swivel component 210 that freely swivels around one axis.

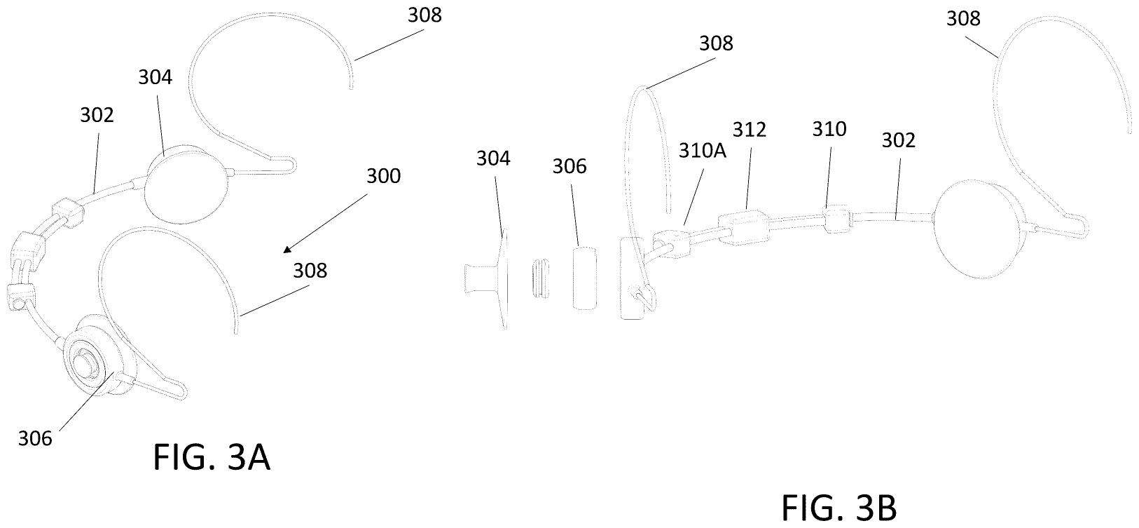

FIGS. 3A-3B show a schematic of an example embodiment of a headband disclosed herein, which is configured for non-surgical retention of at least one abutment of a bone-anchored hearing system.

As shown, the headband 300 includes a support 302 configured to retain the hearing system on the user's head. Similar to headband 200, the support 302 is configured to extend around the back of a user's head, rather than on top. The support 302 is C-shaped, which can allow it to fit around the back of the user's head.

The headband 300 includes at least one abutment 304 configured to transmit vibrations generated by a vibration generated unit. Further, the headband 300 includes an abutment holder 306 associated with the support 302 and configured to retain the at least one abutment 304. The support 302 is configured to be placed on a user's head such that at least one abutment 304 contacts the users head in an area surrounding one of the user's ears.

As shown, the support 302 includes at least one stopper 310 configured to adjust a length of the support 302. The at least one stopper 310 can be at least one wire stopper configured to adjust the length of the wire support. The at least one wire stopper 310 can be used to prevent the wires from dislocating while also holding the wires of the support 302 in place.

The support 302 shown in FIGS. 3A-3B can be a wire support. The wire support allows for more flexibility in the headband. The wire support may further be configured to retain the headband 300 on the user's head via at least one configurable wire earhook 308. The shape of the configurable wire earhook 308 can be adjusted to allow for different head sizes and shapes. As shown in FIGS. 3A-3B, the headband 300 may include two configurable wire earhooks 308.

The at least one wire stopper can include a pair of wire stoppers 310, 310A. The wire support can include a wire holder 312 located between the pair of wire stoppers 310, 310A.

In other words, two preformed metallic wires can be together by a one or more of the wire stoppers 310, 310A and/or wire holder 312 to provide the force to hold the at least one abutment 302 against the head of a user 10. The wires of the support 302 can be length adjusted to provide adjustability for different head sizes. The abutment holder 306 can include a 360-degree self-aligning swivel and a feedback decoupler. The at least one abutment 304 is then suspended in the clearance of the feedback decoupler. The swivel can rotate and revolve inside the abutment holder 306 in two planes at the same time while preventing translation in any direction and adjust as per the contours of the head when the user adjusts the headband 300 as per their comfort. The swivel movements can allow the at least one abutment 304 to maximize contact area with the head and in turn provide a better sound transfer to the skull. The headband 300 can be retained in its position by ear hooks 308 which are replaceable, meaning they can be exchanged with custom hooks as per user's requirements.

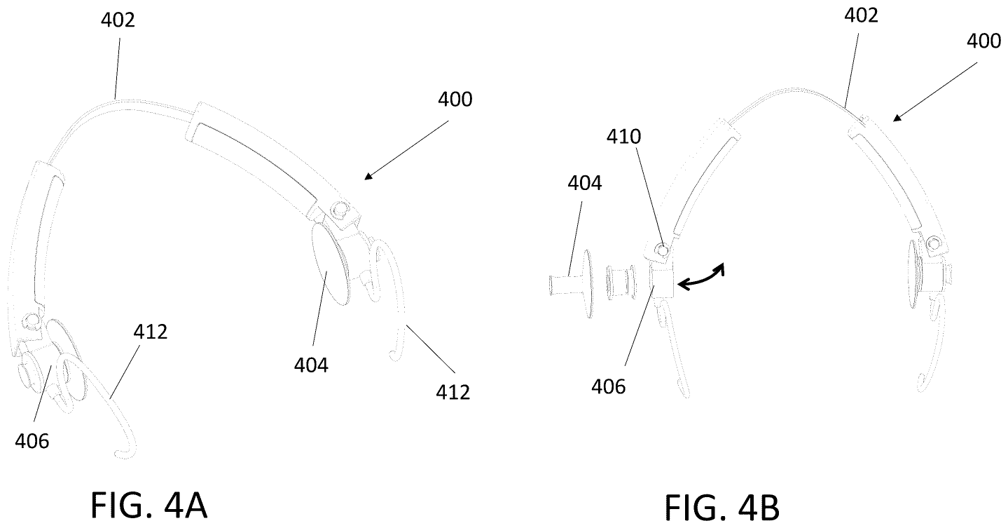

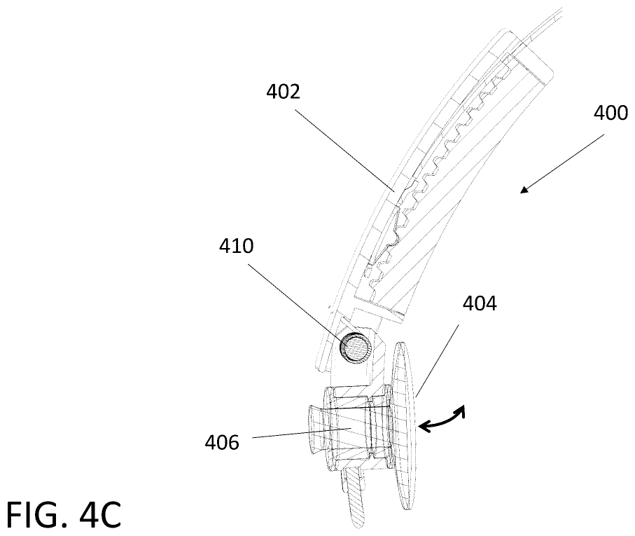

FIGS. 4A-4C show a schematic of an example embodiment of a headband disclosed herein, which is configured for non-surgical retention of at least one abutment of a bone-anchored hearing system.

As shown, the headband 400 includes a support 402 configured to retain the hearing system on the user's head. Similar to headband 100, the support 402 is configured to extend over a top of the user's head. The support 402 is C-shaped, which can allow it to fit around the top of the user's head.

The headband 400 includes at least one abutment 404 configured to transmit vibrations generated by a vibration generated unit. Further, the headband 400 includes an abutment holder 406 associated with the support 402 and configured to retain the at least one abutment 404. The support 402 is configured to be placed on a user's head such that at least one abutment 404 contacts the users head in an area surrounding one of the user's ears. A length adjustable preformed support 402 can provides the adjustability for different head sizes and the force on the at least one abutment 404 in contact with the head.

As shown in FIG. 4C, the abutment holder includes at least one partially loaded spring 410 configured to provide an inward force on the user's head. The headband 400 can include a pair of partially loaded springs 410, as shown in FIG. 4A-4B. For example, the partially loaded springs 410 can be on opposite sides of the support 402, thereby providing an inward force from multiple angles. The at least partially loaded spring 410 can be a torsion spring, but other types of springs can be used.

The length adjustment of the support 402 can be based on a at least one partially loaded spring 410 (e.g., spring click system). The abutment holder 406 rotates on an axle and is pre-loaded with, for example, a torsion spring which provides extra force to firmly retain the at least one abutment 404 on the head while also self-aligning as per the skull contours of the user. The at least one abutment 404 itself is suspended in the clearance of the feedback decoupler. The extra force generated by the at least one partially loaded spring 410 can ensure that the at least one abutment 404 provides a better sound transfer to the skull. Apart from generating extra force, the at least one partially loaded spring 410 maximizes contact of the at least one abutment 404 with the skull in turn leading to a better sound transmission.

The support can optionally include at least one earhook 412, such as the pair of earhooks 412 shown in FIGS. 4A-4B. They earhooks 412 may be useful for retaining the headband 400 on the user. The earhooks 412 may be removable from the headband 400. The headband 400 can be optionally retained in its position by ear hooks 412 which are replaceable meaning they can be exchanged with custom hooks as per user's requirements.

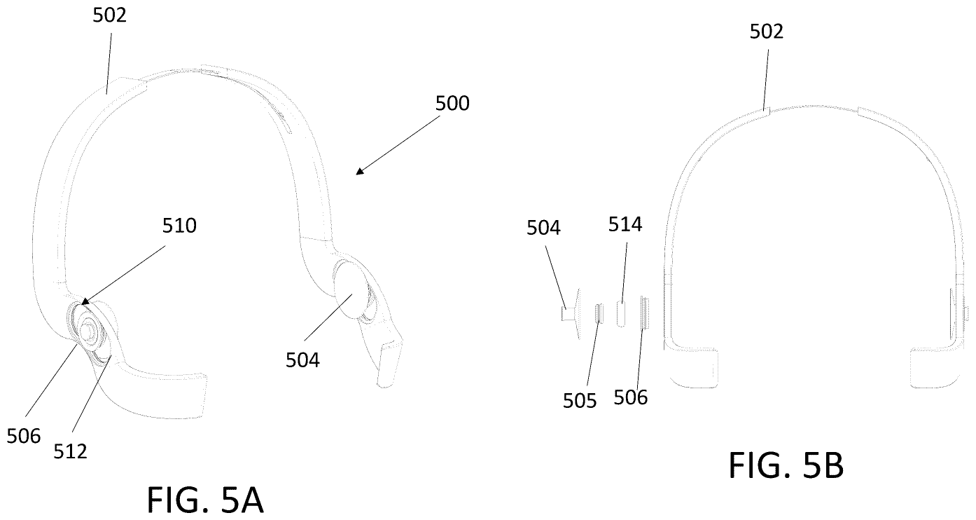

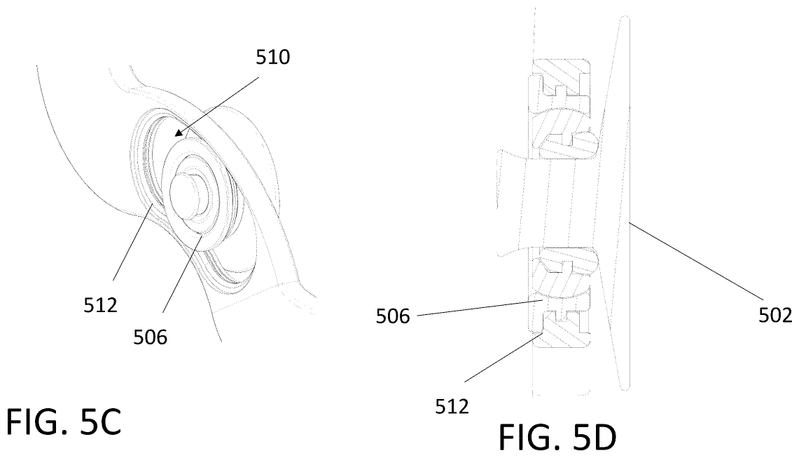

FIGS. 5A-5D show a schematic of an example embodiment of a headband disclosed herein, which is configured for non-surgical retention of at least one abutment of a bone-anchored hearing system.

As shown, the headband 500 includes a support 502 configured to retain the hearing system on the user's head. Similar to headband 100, the support 502 is configured to extend over a top of the user's head. The support 502 is C-shaped, which can allow it to fit around the top of the user's head. A length adjustable preformed support 502 can provide the adjustability for different head sizes, as well as the force on the at least one abutment 504 in contact with the head.

The headband 500 includes at least one abutment 504 configured to transmit vibrations generated by a vibration generated unit. Further, the headband 500 includes an abutment holder 506 associated with the support 502 and configured to retain the at least one abutment 504. The support 502 is configured to be placed on a user's head such that at least one abutment 504 contacts the users head in an area surrounding one of the user's ears.

The support 502 can include an aperture 510 having a track 512. The abutment holder 506 can be configured to translate along the track 512. As the abutment holder 506 retains the at least one abutment 504, the abutment 504 can translate along the track 512 as well. This allows for easier and more comfortable fitting for a user. The headband 500 can also include a feedback decoupler 505.

The support 502 can be associated with the abutment holder 506 via a self-aligning ball joint 514. The self-aligning ball joint can all for 360-degree self-aligning swivel.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Item List

Item 1. A headband configured for non-surgical retention of at least one abutment of a bone-anchored hearing system, the headband comprising:
a support configured to retain the hearing system on a user's head;
at least one abutment configured to transmit vibrations generated by a vibration generating unit;
an abutment holder associated with the support and configured to retain the at least one abutment;
   wherein the support is configured to be placed on a user's head such that the at least one abutment contacts the users head in an area surrounding one of the user's ears;
   characterized in that:
the support comprises at least one stopper configured to adjust a length of the support.

Item 2. Headband of Item 1, wherein the support comprises a wire support configured to retain the headband on a user's head via at least one configurable wire earhook.

Item 3. Headband of Item 2, wherein the at least one stopper comprises at least one wire stopper configured to adjust the length of the wire support.

Item 4. Headband of Item 3, wherein the at least one wire stopper comprises a pair of wire stoppers, and wherein the wire support comprises a wire holder located between the pair of wire stoppers.

Item 5. Headband of any one of Items 2-4, wherein the wire support comprises a first wire support and a second wire support.

Item 6. Headband of Item 5, wherein the wire holder comprises a first aperture and a second aperture, and wherein the first wire support extends through the first aperture and the second wire support extends through the second aperture.

Item 7. Headband of any one of Items 5-6, wherein the at least one stopper is configured to receive and retain an end of the first wire support, and the second wire support can extend through the at least one wire stopper.

Item 8. Headband of any one of Items 1-7, further comprising two configurable wire earhooks.

Item 9. A headband configured for non-surgical retention of at least one abutment of a bone-anchored hearing system, the headband comprising:
a support configured to retain the hearing system on a user's head;
an abutment configured to transmit vibrations generated by a vibration generating unit;
an abutment holder associated with the support configured to retain the abutment;
   wherein the support is configured to be placed on a user's head such that the abutment contacts the users head in an area surrounding one of the user's ears;
   characterized in that:
the abutment holder comprises at least one partially loaded spring configured to provide an inward force on the user's head.

Item 10. Headband of Item 9, wherein the headband comprises a pair of partially loaded springs.

Item 11. Headband of Item 10, wherein each of the pair of partially loaded springs can be located on opposite sides of a user's head when worn.

Item 12. Headband of any one of Items 9-11, wherein the at least one partially loaded spring comprises a torsion spring.

Item 13. Headband of any one of Items 9-12, wherein the support comprises a pair of earhooks.

Item 14. Headband of any one of Items 9-13, wherein at least one partially loaded spring is configured to rotate the abutment holder about a rotation axis with respect to the support.

Item 15. Headband of Item 14, wherein the rotation axis is perpendicular to the support.

Item 16. Headband of any one of Items 9-15, wherein the support is preformed and configured to apply an inward force on the user's head.

Item 17. A headband configured for non-surgical retention of at least one abutment of a bone-anchored hearing system, the headband comprising:
a support configured to retain the hearing system on a user's head;
at least one abutment configured to transmit vibrations generated by a vibration generating unit;

an abutment holder associated with the support and configured to retain the at least one abutment;

wherein the support is configured to be placed on a user's head such that the at least one abutment contacts the user's head in an area surrounding one of the user's ears;
characterized in that:
the support comprises at least one telescoping feature configured to adjust a length of the support; and
the abutment holder is configured to retain the at least one abutment with a self-aligning two-axis swivel.

Item 18. Headband of Item 17, wherein the at least one abutment comprises a contact element, the contact element being configured to transmit vibrations generated by the vibration generating unit towards a contact surface of the contact element.

Item 19. Headband of Item 17 or 18, wherein the support is configured for wearing on top of the user's head.

Item 20. Headband of any one of Items 17-19, wherein:
the abutment holder comprises a body, a first inner ring configured to be retained within the body, and a second inner ring configured to be retained within the first inner ring;
   wherein the first inner ring is configured to rotate with respect to the body about a first axis;
   wherein the second inner ring is configured to rotate with respect to the first inner ring about a second axis;
   wherein the first axis and the second axis are different.

Item 21. Headband of Item 20, wherein the first axis and the second axis are orthogonal.

Item 22. A headband configured for non-surgical retention of at least one abutment of a bone-anchored hearing system, the headband comprising:
a support configured to retain the hearing system on a user's head;
at least one abutment configured to transmit vibrations generated by a vibration generating unit;
an abutment holder associated with the support configured to retain the at least one abutment;
   wherein the support is configured to be placed on a user's head such that at least one abutment contacts the users head in an area surrounding one of the user's ears;
   characterized in that:
the at least one abutment is configured to receive an adhesive;
   the abutment holder is associated with the support via a self-aligning swivel component; and the at least one abutment is configured to retain the abutment holder via a bayonet style coupling.

Item 23. Headband of Item 22, wherein the at least one abutment is on an opposite side of the support and the self-aligning swivel component from the abutment holder.

Item 24. Headband of Item 22 or 23, wherein the at least one abutment is configured to retain the self-aligning swivel component.

Item 25. A headband configured for non-surgical retention of at least one abutment of a bone-anchored hearing system, the headband comprising:
a support configured to retain the hearing system on a user's head;
at least one abutment configured to transmit vibrations generated by a vibration generating unit;
an abutment holder associated with the support and configured to retain the at least one abutment;
   wherein the support is configured to be placed on a user's head such that the at least one abutment contacts the users head in an area surrounding one of the user's ears;
   characterized in that:
the support comprises an aperture having a track, wherein the abutment holder is configured to translate along the track.

Item 26. Headband of Item 25, wherein the support is associated with the abutment holder via a self-aligning ball joint.

Item 27. Headband of any one of the previous Items, wherein the at least one abutment comprises a single abutment.

Item 28. Headband of any one of Items 1-26, wherein the at least one abutment comprises two abutments.

Item 29. Headband of Item 28, wherein the abutment holder comprises two abutment holders, wherein each of the two abutment holders is associated with one of the two abutments.

Item 30. Headband of any one of the previous Items, wherein the support is C-shaped.

Item 31. Headband of any one of the previous Items, wherein the abutment holder is configured to retain the at least one abutment with a self-aligning two-axis swivel.

Item 32. Headband of any one of Items 1-30, wherein the support is associated with the abutment holder via a self-aligning ball joint.

1. A headband configured for non-surgical retention of at least one abutment of a bone-anchored hearing system, the headband comprising:
a support configured to retain the hearing system on a user's head;
at least one abutment configured to transmit vibrations generated by a vibration generating unit;
an abutment holder associated with the support and configured to retain the at least one abutment;
wherein the support is configured to be placed on a user's head such that the at least one abutment contacts the users head in an area surrounding one of the user's ears;
characterized in that:
the support comprises at least one stopper configured to adjust a length of the support;
the at least one stopper comprises at least one wire stopper configured to adjust the length of the wire support; and
the at least one wire stopper comprises a pair of wire stoppers, and wherein the wire support comprises a wire holder located between the pair of wire stoppers.

2. Headband of claim 1, wherein the support comprises a wire support configured to retain the headband on a user's head via at least one configurable wire earhook.

3. Headband of claim 1, wherein the wire support comprises a first wire support and a second wire support.

4. Headband of claim 3, wherein the wire holder comprises a first aperture and a second aperture, and wherein the first wire support extends through the first aperture and the second wire support extends through the second aperture.

5. Headband of claim 3, wherein the at least one stopper is configured to receive and retain an end of the first wire support, and the second wire support can extend through the at least one wire stopper.

6. Headband of claim 1, further comprising two configurable wire earhooks.

7. Headband of claim 1, wherein the at least one abutment comprises a single abutment.

8. Headband of claim 1, wherein the at least one abutment comprises two abutments.

9. Headband of claim 8, wherein the abutment holder comprises two abutment holders, wherein each of the two abutment holders is associated with one of the two abutments.

10. Headband of claim 1, wherein the support is C-shaped.

11. Headband of claim 1, wherein the abutment holder is configured to retain the at least one abutment with a self-aligning two-axis swivel.

12. Headband of claim 1, wherein the support is associated with the abutment holder via a self-aligning ball joint.

13. A headband configured for non-surgical retention of at least one abutment of a bone-anchored hearing system, the headband comprising:
a support configured to retain the hearing system on a user's head;
an abutment configured to transmit vibrations generated by a vibration generating unit;
an abutment holder associated with the support configured to retain the abutment;
wherein the support is configured to be placed on a user's head such that the abutment contacts the users head in an area surrounding one of the user's ears;
characterized in that:
the abutment holder comprises at least one partially loaded spring configured to provide an inward force on the user's head.

14. Headband of claim 13, wherein the headband comprises a pair of partially loaded springs.

15. Headband of claim 14, wherein each of the pair of partially loaded springs can be located on opposite sides of a user's head when worn.

16. Headband of claim 13, wherein the at least one partially loaded spring comprises a torsion spring.

17. Headband of claim 13, wherein the support comprises a pair of earhooks.

18. Headband of claim 13, wherein at least one partially loaded spring is configured to rotate the abutment holder about a rotation axis with respect to the support.

19. Headband of claim 18, wherein the rotation axis is perpendicular to the support.

20. A headband configured for non-surgical retention of at least one abutment of a bone-anchored hearing system, the headband comprising:
a support configured to retain the hearing system on a user's head;
at least one abutment configured to transmit vibrations generated by a vibration generating unit;
an abutment holder associated with the support and configured to retain the at least one abutment;
wherein the support is configured to be placed on a user's head such that the at least one abutment contacts the user's head in an area surrounding one of the user's ears;
characterized in that:
the support comprises at least one telescoping feature configured to adjust a length of the support; and
the abutment holder is configured to retain the at least one abutment with a self-aligning two-axis swivel.
